(19) United States
(12) Patent Application Publication
(10) Pub. No.: US 2024/0227092 A9
(43) Pub. Date: Jul. 11, 2024

(54) ADDITIVE MANUFACTURING SYSTEM AND METHOD FOR RAILROAD RAIL AND TRAIN WHEEL REPAIR

(71) Applicants: Zhiyong Wang, Henderson, NV (US); Hualiang Teng, Henderson, NV (US)

(72) Inventors: Zhiyong Wang, Henderson, NV (US); Hualiang Teng, Henderson, NV (US)

(21) Appl. No.: 18/048,767

(22) Filed: Oct. 21, 2022

(51) Int. Cl. B23P 6/00

(52) U.S. Cl. CPC B23P 6/00

(57) ABSTRACT

Systems and methods in which worn railroad rails and wheels are repaired. For rail repair, a mobile additive manufacturing unit (i.e., 3D printer) operates along the rail and dispenses molten metal on the previously prepared portion of the rail. Reinforcing composite materials in powder form or pieces of composite materials may be added to the molten metal to enhance mechanical properties. For wheel repair, a fixed additive manufacturing unit is used in the same or similar manner as the mobile additive manufacturing unit for the rails albeit the wheel is rotated relative to the additive manufacturing unit. The repaired surface of the rails and wheels have dimension accuracies and surface finishes that are substantially the same as the original rails and wheels with the same or better mechanical strength and hardness as the original after resurfacing with grinding or milling tools.

### STATEMENT REGARDING FEDERALLY SPONSORED RESEARCH

The present invention was made with government support under grants awarded by the U.S. Department of Transportation. The government has agreed to return rights in the invention to the inventors.

### FIELD OF THE INVENTION

The embodiments of the present invention relate to a system and method for repairing worn railroad rails and wheels using additive manufacturing.

### BACKGROUND

Over time, due to frequent train usage, railroad rails and wheels wear out. The wear includes deterioration of surface finish, rail head corrugation, longitudinal and transverse shelling, cracking, spalling, fatigue damage, shearing, worn rail heads, and plastic deformation lip, which can lead to vibration and noise. The vibration and noise may cause discomfort to train passengers. If not timely repaired, worn rails and/or wheels can lead to crashes and even derailment causing passenger injury or death.

Generally, when the rails or wheels are worn significantly, they are replaced with new rails or wheels.

Thus, there exists a need for a system and method for repairing worn rails and wheels that eliminates the need for complete replacement. As detailed below, an additive manufacturing system and method can be used to repair the worn rails and wheels.

### SUMMARY

The embodiments of the present invention provide for systems and methods in which worn railroad rails and train wheels are cleaned using, for example, water jets or torch flame treatment and then prepared for repair by grinding/milling to remove the worn layers or portions of the rails or wheels. For rail repair, a mobile additive manufacturing unit (i.e., 3D printer) moves along the rail and dispenses molten metal on the previously prepared portion of the rail. In one embodiment, reinforcing composite materials in powder form or pieces of composite materials may be added to the molten metal to enhance its mechanical properties. For wheel repair, fixed additive manufacturing unit is used in the same or similar manner as the mobile additive manufacturing unit for the rails. The repaired surface of the rails and wheels have dimension accuracies and surface finishes that are substantially the same as the original rails and wheels with the same or better mechanical strength and hardness as the original after resurfacing with grinding or milling tools. The embodiments of the present may be used for any rail or wheel surface exhibiting wear. The systems and methods described herein may be utilized with both horizontal and vertical surfaces.

To implement the method on rail, a mobile unit housing an additive manufacturing printer is utilized. A cleaning or prep unit and a surface truing unit may also be housed in the system and be mobile on a railroad track with a driving system.

In one embodiment, the additive manufacturing printer comprises a sealed container embedded with electrical heating elements in or on container walls maintaining the temperature inside the container at no less than 1,200° C. In one embodiment, at least one pair of metal wires are fed close to each other through an inner, top section of the container. Then at least one pair of metal wires generate an electric arc between tips thereof due to a voltage difference applied to the wires. Accordingly, the wire tips melt and drip to a cone-shaped bottom of the container and remain in a molten state due to the heating elements. As wires are fed continuously towards each other, arcing continues, causing metal wires to melt continuously to fill the cone-shaped container. In one embodiment, the container is air-leak proof, or inert gas protected to prevent metal oxidation/nitridation/hydrogenation by air and to reduce air bubbles in the molten metal.

A lid positioned near an end of the cone-shaped funnel regulates flow of the molten metal onto the rail or wheel surface. In a simplified embodiment, a sealed container may not be necessary as the paired metal wires are in air or an inert gas environment such that molten metals may drip directly onto the rail or wheel surface.

To prevent molten metal from flowing off the rail surface, a mold comprising a pair of long thin sheets, made of ceramic, copper or other materials, is placed along the rail, forming the shape of a “shoe” about the rail. A lower section of the shoe is made in the same cross-sectional shape as the rail and presses towards the rail surface to prevent molten metal leakage. A top portion of the long thin sheets extend outward at an angle between 10°-80° to contain molten metal from spilling. In a simplified embodiment with no air-tight container, copper sheets are used to make the shoes. Otherwise, ceramics and other high-melting-point materials are used. Coatings may be applied to the shoe surface for easy separation from the rail after repair.

A cleaning or prep unit comprises at least a grinder or milling cutter, a water jet unit, and/or a torch unit for heat treatment. The grinder or milling cutter is used to remove the strained layers of the rail, the water jet unit to remove, if needed, rail contamination and the torch unit to burn off surface contaminants and heat treat the rail to a desired temperature before printing.

The surface truing unit is made of at least one grinder or milling cutter to remove excess material added to the rail by the printer to keep dimension accuracy and surface finish of the rail substantially the same as the original rail. The surface truing unit and the cleaning or prep unit may connect with each other partially or totally. The surface truing processes include some or all of the following steps. First, excess material is removed. Second, the added material on the rail is squeezed/pressured using mechanical/hydraulic rollers or hammers to strengthen the newly added layer. Optionally, after squeezing/pressuring, a shot peening process may be used to convert surface stresses from tensile to compressive in the 3D printed layer. Next, the remaining excess material on rail is removed by grinding/milling with consideration of thermal shrinkage of the rail.

Other variations, embodiments and features of the present invention will become evident from the following detailed description, drawings and claims.

### BRIEF DESCRIPTION OF THE DRAWINGS

FIG. 1 illustrates a cross-sectional view of a rail mold assembly according to the embodiments of the present invention;

FIG. 2 illustrates a perspective view of the rail assembly according to the embodiments of the present invention;

FIG. 3 illustrates a perspective view of a wheel mold assembly with the wheel sandwiched between the mold from both sides according to the embodiments of the present invention;

FIG. 4A illustrates an exemplary container according to the embodiments of the present invention;

FIG. 4B illustrates a transparent view of the exemplary container according to the embodiments of the present invention;

FIG. 5 illustrates a flow chart detailing one methodology of repairing a railroad rail according to the embodiments of the present invention;

FIG. 6 illustrates a flow chart detailing one methodology of repairing a rail car wheel according to the embodiments of the present invention; and

FIG. 7 illustrates an exemplary additive manufacturing device and platform for repairing a railroad rail according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the virtual, digital and online embodiments of the present invention involve both hardware and software elements the portion of which are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, radio frequency (RF) and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely or partly on the user's computer, as a standalone software package, or partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with the reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions, which execute on the computer or other programmable apparatus, provide processes for implementing the functions/acts specified in the flowchart and/or block diagrams.

A rail repair process broadly comprises operating a mobile additive manufacturing unit to a portion of rail exhibiting surface wear requiring repair. A cleaning or prep unit may apply a water jet to clean the subject area to remove any contamination. One or more grinder or milling cutter machines may be used to remove the strained layers in the rail. Grooves or channels may be cut in the rail for the purpose of strengthening the layers of material to be added to the rail. Reinforcing bars or rods may be installed into the grooves and channels in the rail if needed to add strength to the to-be-added metal layers.

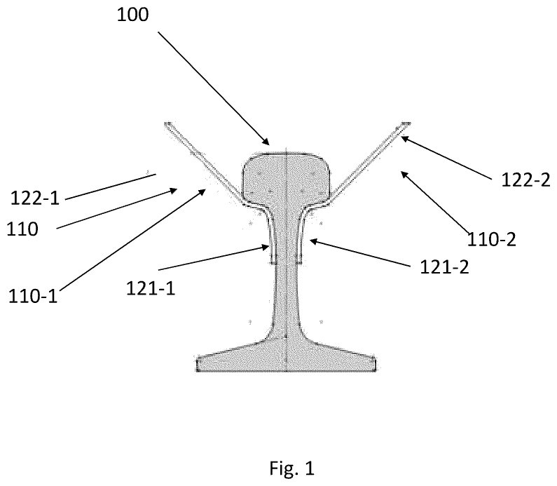

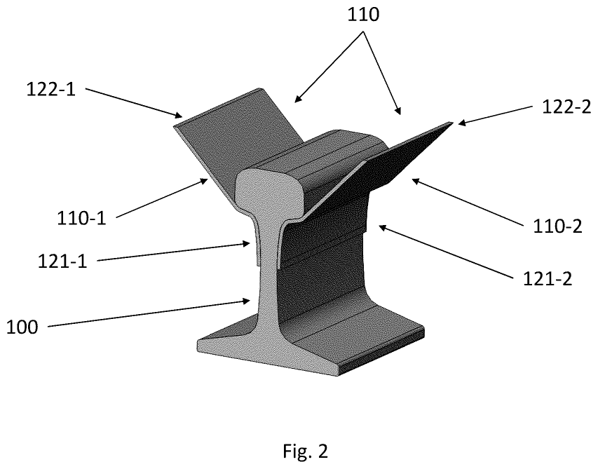

Now referring to FIGS. 1 and 2, a rail mold 110 comprises a pair of long thin sheets 120-1, 120-2, made of materials including, for example, ceramic or copper. As shown, one of the long thin sheets 110-1 is positioned on one side of, and in contact with, a rail 100 and a second one of the long thin sheets 110-2 is positioned on a second side of, and in contact with, the rail 100 taking the shape of a shoe. A lower section 121-1, 121-2 of each of the long thin sheets 110-1, 110-2 is shaped to conform to the rail 100 to press tightly towards the rail 100 to prevent molten metal leakage during repair, whereas the top section 122-1, 122-2 of each of the long thin sheets 110-1, 110-2 extends outward at an angle of between about 10°-80° to contain molten metal from spilling. As shown in FIG. 1, the angle is 45° but those skilled in the art will recognize that the angle may be greater or less than 10°-80°.

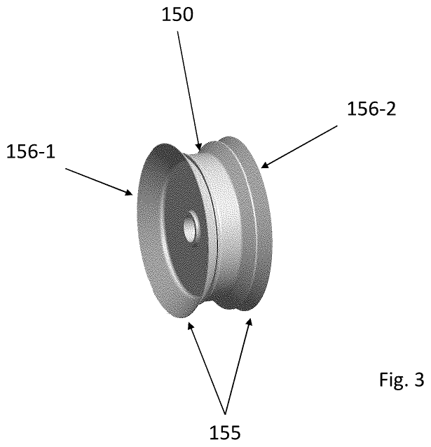

Now referring to FIG. 3, a wheel mold 155 is used with the repair of a rail car wheel 150. The wheel mold 155 comprises two halves 156-1 and 156-2 which are configured to fit into the outer wheel cavities. Like rail mold 100, wheel mold 155 is designed to prevent molten metal leakage during the repair process.

In one embodiment, the rail mold and wheel mold are attached to the rail and wheel, respectively, using clamps (e.g., C-clamps, hydraulic clamps and/or mechanical clamps). Other connectors may be used to attach the molds to the rail and wheel.

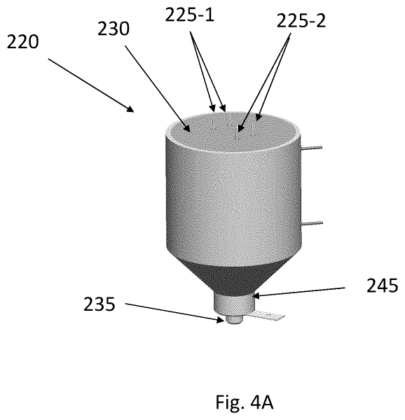

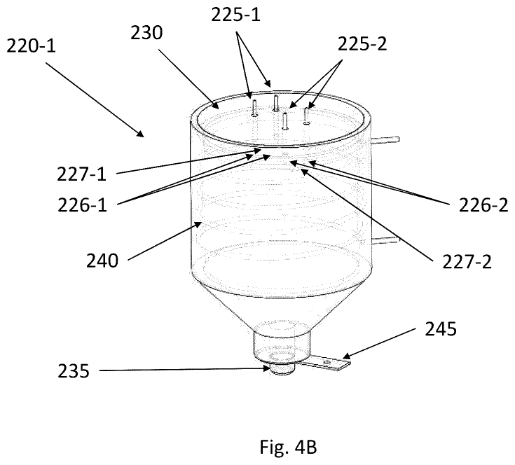

FIGS. 4A and 4B show a container 200 of the type used to facilitate the process detailed herein. In one embodiment, the container 220 is air-tight with two pairs of metal wires 225-1 and 225-2. The two pairs of metal wires 225-1 and 225-2 extend into the container 200 through a top surface 230 thereof. During operation, a voltage, in the range of about 10-200 volts, is applied to each pair of wires 225-1 and 225-2. Given the proximity of the tips 226-1 and 226-2 of the wires in the container 200, as best shown in FIG. 4B, the application of a voltage causes electrical arcing 227-1 and 227-2 at the tips 226-1 and 226-2 thereby melting the wire tips. As wire is fed continuously into the container 200, the tips 226-1 and 226-2 melt and drip continuously to the bottom 235 of the container 200. Heating elements 240 illustrated in FIG. 3B take a helical shape on the inner container wall. The heating elements 240 may take on any configurations. A cover 245 closes the bottom 235 of the container 200. The cover 245, which may open and close, serves to regulate the flow volume of molten metals from the container 200 onto a rail or wheel below.

The wires 225-1 and 225-2 may be various compositions of metals. Tables 1 and 2 show seven exemplary metal wire compositions. Those skilled in the art will recognize that alloys and/or composites may be used alone or in combination with the elements set forth in Tables 1 and 2 and may be added in some applications to enhance mechanical property of the rail/wheel. Table 3 presents two exemplary chemical compositions for the metal flux as detailed below. Table 4 lists exemplary chemical compositions of the to-be-repaired rails. Table 5 shows exemplary mechanical properties for typical light and heavy rails.

TABLE 1
Chemical composition of the wires (wt. %).

| Material | Fe | C | Cr | Mn | Si | Ni | O | N | P | S | Cu | Mo | Al | Ti |
|---|---|---|---|---|---|---|---|---|---|---|---|---|---|---|
| Example 1 | Bal. | 0.18 | — | 1.2 | 0.8 | 0.40 | 0.03 | 0.030 | 0.025 | 0.025 | — | — | 0.5 | 0.05 |
| Example 2 | Bal. | 0.12 | 0.50 | 2.75 | 3.30 | — | — | — | — | — | — | 0.85 | — | — |
| Example 3 | Bal. | 0.17 | 2.8 | 2.6 | 1.3 | — | — | — | — | — | — | 0.4 | — | — |

TABLE 2
Chemical composition of the wires (wt. %).

| Material | Co | Fe | C | Cr | Mn | Mo | Si | Ni | P | S | W |
|---|---|---|---|---|---|---|---|---|---|---|---|
| Example 4 | — | Bal. | 0.03 | 19.0 | 2.00 | — | 1.00 | 10.5 | 0.045 | 0.03 | — |
| Example 5 | — | Bal. | 0.01 | 13.5 | 0.50 | 0.01 | 0.47 | 0.08 | 0.02 | 0.03 | — |
| Example 6 | Bal. | 0.10 | 1.2 | 30.5 | 0.02 | 0.01 | 1.55 | 0.70 | 0.03 | 0.01 | 5.00 |
| Example 7 | Bal. | 0.15 | 0.23 | 27.0 | 0.60 | 5.00 | 0.85 | 2.10 | 0.01 | 0.01 | 0.05 |

TABLE 3
Chemical composition of the agglomerated flux used for the repair process (wt. %).

| Flux | SiO₂ | CO₂ | Al₂O₃ | CrO | MgO | MoO₃ | CaO | CaF₂ | MnO | TiO₂ | Na₂O | Fe₂O₃ |
|---|---|---|---|---|---|---|---|---|---|---|---|---|
| Example 1 | 10.7 | — | 17.3 | — | 31.7 | — | 6.6 | 24.1 | 1.1 | 0.86 | 0.78 | 1.9 |
| Example 2 | 10.0 | 21.2 | — | 8.9 | — | 18.4 | — | — | 14.2 | — | — | 22.7 |

TABLE 4
Chemical composition of the to-be-repaired rail steels (wt. %).

| Material | Fe | C | Cr | Mn | Si | Ni | P | S |
|---|---|---|---|---|---|---|---|---|
| Light rail | Bal. | 0.71 | — | 1.04 | 0.21 | — | 0.022 | 0.013 |
| Heavy rail | Bal. | 0.80 | 0.03 | 0.23 | 0.04 | 0.14 | 0.01 | 0.01 |

TABLE 5
Required mechanical properties for the light and heavy rails

| | Yield | Tensile | Vickers hardness | Elonga- |
|---|---|---|---|---|
| Material | strength (MPa) | strength (MPa) | number (HV) | tion (%) |
| Light rail | 460 | 830 | 222 | 10 |
| Heavy rail | 511 | 980 | 318 | 10 |

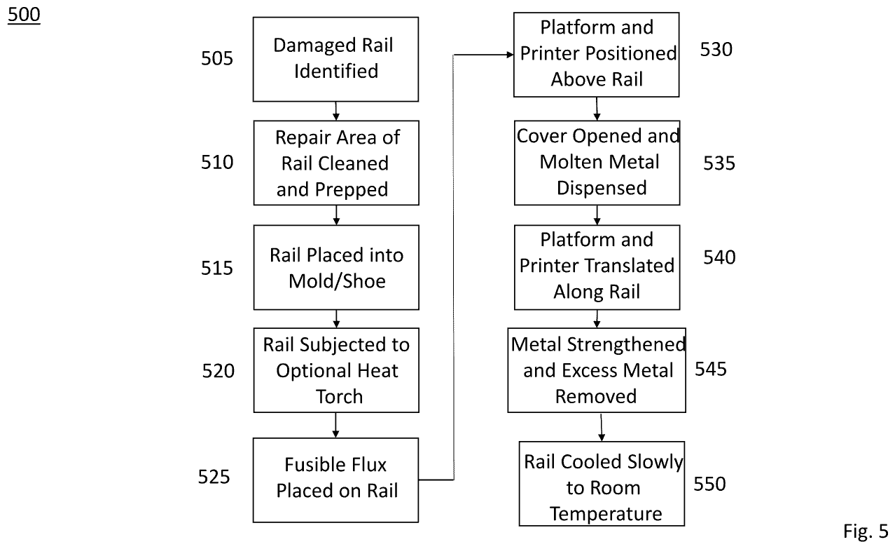

FIG. 5 shows a flow chart 500 detailing one methodology of rail repair according to the embodiments of the present invention. At 505, a damaged rail area is identified. At 510, the repair area of the rail may be cleaned using a water jet or similar means. At 515, the mold/shoe is placed on the rail. This is normally done while the rail remains in its installed location by means of a mobile repair unit. Alternatively, the rail may be transported to a shop or similar location to be repaired. At 520, the rail may be optionally subjected to one or more heating torches to raise the temperature of the rail to minimize thermal and mechanical stresses in the rail and to increase metallurgical bonding strength between the added material and the rail. In one embodiment, the rail is heated between 100° C. to 1,000° C. Lesser and greater temperatures may also be targeted. At 525, the rail may be optionally treated with a blanket of granular fusible flux comprising lime, silica, manganese oxide, calcium fluoride and/or other compounds. The fusible flux serves to reduce oxidation, nitridation and hydrogenation on the rail. In one embodiment, the fusible flux is applied using a funnel-type apparatus. The rail mold/shoe prevents flux from falling from the rail. Table 3 shows exemplary compositions which may form the flux. Alternatively, in some applications, an inert gas, such as argon, may be used instead of fusible flux.

Once the fusible flux is applied, at 530, the platform and additive manufacturing unit (including Container 200) is positioned above or on the rail. Once aligned, at 535, the cover 245 is opened and the additive manufacturing unit is activated whereby the wire tips melt due to the applied voltage (i.e., electrical energy) and molten metal falls in a controlled flow mode to the bottom of Container 200 and passes through the opening onto the rail. While electrical energy is disclosed, other forms of energy including laser, electron beam, plasma, thermal and chemical may also be used to melt the metal. At 540, the additive manufacturing unit is moved above the rail via an automated platform so that molten metal may be dropped on the entire rail repair area. In one embodiment, a drive system comprising at least a motor translates the platform and additive manufacturing unit above and along the rail. An integral alignment device may maintain the platform and 3D printer in the correct orientation relative to the rail. Once dropped and in contact with the rail, the molten metal solidifies to the rail and flux blanket. Depending on the depth of the rail damage, this process may proceed in a layer-by-layer manner until the rail wear/damage is fully repaired (e.g., enough molten metal is dropped to build up the damaged rail). In one embodiment, flux is used between each layer. In one embodiment, a vacuum tube sucks excess flux from the rail or layer of molten metal. If needed or desired, reinforcing composite materials in forms such as powders or short metal pieces may be added to the molten metal to enhance mechanical properties of the rail.

At 545, a grinder or milling cutter is used to grind any excess materials off the rail surface and thus achieve the exact or nearly-exact surface dimension and surface finish on the rail. A fire-proof blanket may be used to cover the newly repaired rail to slow down the cooling process to minimize thermal and mechanical stresses in the rail.

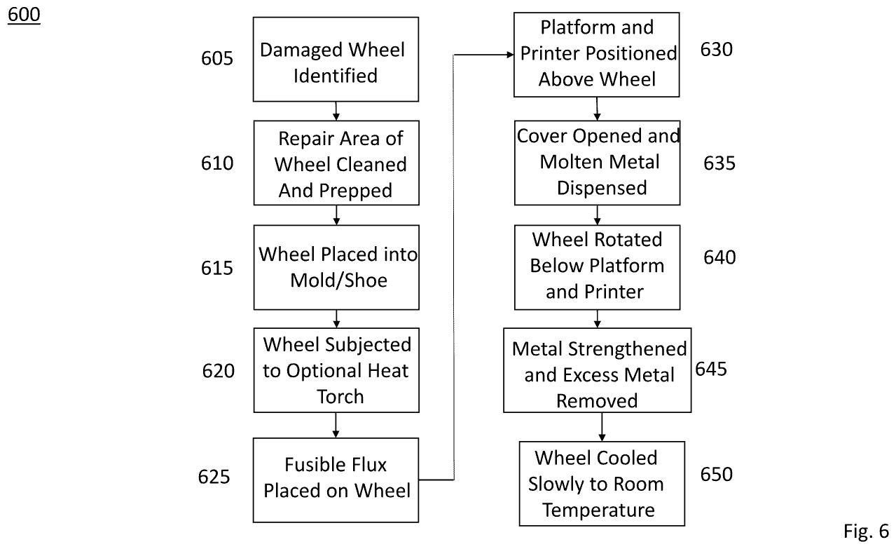

In general, repairing a wheel follows the same basic steps as shown in the flow chart 500. One difference is that the wheel is turned under the additive manufacturing unit rather than the additive manufacturing unit being translated about the wheel. The wheel mold/shoe is also configured differently but serves the same purpose to prevent leakage of flux and molten metal. FIG. 6 shows a flow chart 600 detailing one methodology of wheel repair according to the embodiments of the present invention.

At 605, a damaged wheel area is identified. At 610, the repair area of the wheel may be cleaned using a water jet or similar means. At 615, the mold/shoe is placed on one or both sides of the wheel. At 620, the wheel may be optionally subjected to one or more heating torches to raise the temperature of the wheel to minimize thermal and mechanical stresses in the wheel and to increase metallurgical bonding strength between the added material and the wheel. In one embodiment, the wheel is heated between 100° C. to 1,000° C. Lesser and greater temperatures may also be targeted. At 625, the wheel may be optionally treated with a blanket of granular fusible flux comprising lime, silica, manganese oxide, calcium fluoride and/or other compounds. The wheel mold/shoe prevents flux from pouring from the wheel. Alternatively, in some applications, an inert gas, such as argon, may be used instead of fusible flux.

Once the fusible flux is applied, at 630, the wheel and additive manufacturing unit (including the container 200) are positioned relative to one another. Once positioned, at 635, Cover 245 is opened and the additive manufacturing unit is activated whereby the wire tips melt and molten metal pours in a controlled flow mode to the bottom of container 200 and passes through the opening onto the wheel. At 640, the wheel is rotated so that molten metal may be dropped on the entire wheel repair area. Once dropped and being in contact with the wheel, the molten metal solidifies to the wheel and flux blanket. Depending on the depth of the wheel damage, this process may proceed in a layer-by-layer manner until the wheel wear/damage is fully repaired (e.g., enough molten metal has been dropped to build up the damaged wheel). In one embodiment, flux is used between each layer. In one embodiment, a vacuum tube sucks excess flux from the wheel or layer of molten metal. If needed or desired, reinforcing composite materials in forms such as powders. Short metal pieces may be added to the molten metal to enhance mechanical properties of the wheel.

At 645, a grinder or milling cutter is used to grind any excess materials off the wheel surface and thus achieve the exact or nearly-exact surface dimension and finish on the wheel. A fire-proof blanket may be used to cover the newly repaired wheel to slow down the cooling process to minimize thermal and mechanical stresses in the wheel.

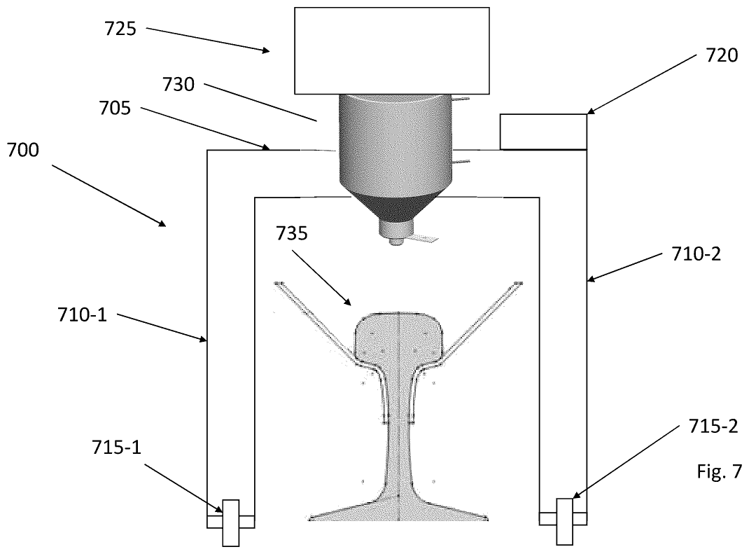

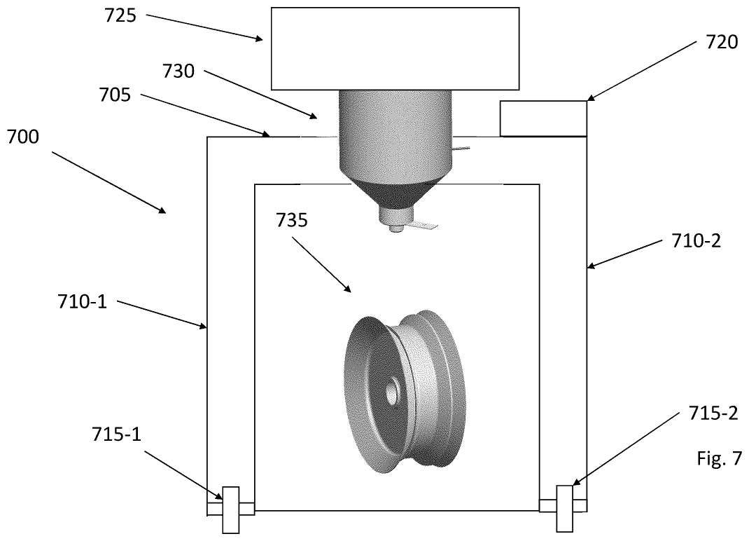

FIG. 7 shows an exemplary platform arrangement of the type suitable for the embodiments of the present invention. As shown, platform 700 comprises base 705 and supports 710-1 and 710-2. Wheels 715-1 and 715-2 and motor 720 provide means for the platform 700 to move in the working place. The additive manufacturing unit 725 including container 730 is supported by the base 705 so that the bottom of the container 730 is above the area of the rail 735 requiring repair. During the operation, the platform 700 is translated above and along the rail 735 so that the molten metal within the container 730 may be dispended onto the rail 735. The speed and path (including layered back-and-forth movements) of the platform 700 and flow rate of the molten metal from the container 730 is controlled by a processor associated with the additive manufacturing unit 725.

With regard to the processes, systems, methods, heuristics, etc. described herein, it should be understood that, although the steps of such processes, etc. have been described as occurring according to a certain ordered sequence, such processes could be practiced with the steps performed in different orders than that described herein. It further should be understood that certain steps could be performed simultaneously, that other steps could be added, or that certain steps described herein could be omitted. In other words, the descriptions of processes herein are provided for the purpose of illustrating certain aspects of the present disclosure and should in no way be construed to limit the disclosure.

Although the invention has been described in detail with reference to several embodiments, additional variations and modifications exist within the scope and spirit of the invention as described and defined in the following claims.

1. A system for repairing rail comprising:
a mobile platform configured to retain an additive manufacturing unit above a subject rail to be repaired, said mobile platform configured to translate said additive manufacturing unit above said subject rail to be repaired, said additive manufacturing unit further configured to create molten metal or metals and retain said molten metal and metals in a container configured to maintain the molten metal or metals at a pre-established temperature;
a rail mold configured to prevent molten metal leakage during repair of said subject rail;
a prep unit configured to clean an area of said rail to be repaired;
wherein said additive manufacturing unit is configured to dispense continuously one or more layers of molten metal or metals from said container onto said area of said rail to be repaired as said platform translates said additive manufacturing unit above said subject rail to be repaired; and
a surface truing unit configured to treat the rail after said one or more layers of molten metal or metals have been dispensed onto the rail.

2. The system of claim 1 wherein the molten metal or metals include reinforcing alloys and/or composites.

3. The system of claim 1 further comprising a heating unit configured to heat said rail, prior to repair, to reduce thermal and mechanical stresses which may occur during repair.

4. The system of claim 1 further comprising said additive manufacturing unit being configured to dispense one or more layers of fusible flux onto said area of said rail to be repaired.

5. (canceled)

6. The system of claim 1 wherein said rail mold comprises a pair of metallic and/or ceramic sheets with lower sections in a same shape as said rail to press closely thereto and top sections angled outwards from the rail.

7. The system of claim 6 further comprising a coating between the metallic and/or ceramic sheet surfaces and the rail, said coating configured to facilitate separation of the rail mold and the rail.

8. The system of claim 1 wherein said surface truing unit is configured to: remove excess material, apply pressure using rollers or hammers and/or shot peen the rail surface.

9. The system of claim 1 wherein the prep unit is further configured to cut grooves or channels in the rail and to install reinforcing bars and/or rods into the grooves and channels in the rail.

10. A system for repairing train wheels comprising:
a platform configured to retain an additive manufacturing unit above a subject wheel to be repaired, said platform configured to retain said additive manufacturing unit above said subject wheel to be repaired;
a wheel mold configured to prevent molten metal leakage during repair of said subject wheel;
a cleaning unit configured to clean an area of said wheel to be repaired;
wherein said additive manufacturing unit is configured to dispense one or more layers of molten metal or metals onto said area of said wheel to be repaired as said wheel rotates beneath said additive manufacturing unit; and
a surface truing unit configured to treat the wheel after said one or more layers of molten metal or metals have been dispensed onto the wheel.

11. The system of claim 10 further comprising a heating unit configured to heat said wheel, prior to repair, to reduce thermal and mechanical stresses which may occur during repair.

12. The system of claim 10 further comprising said additive manufacturing unit being configured to dispense one or more layers of fusible flux onto said area of said wheel to be repaired.

13. The system of claim 10 wherein said additive manufacturing unit creates molten metal or metals and retains said molten metal or metals in a container until such time as said molten metal or metals are ready to be poured onto said wheel to be repaired.

14. The system of claim 10 wherein said wheel mold comprises a pair of metallic sheets and/or ceramic sheets with lower sections in a same shape as said wheel to press closely thereto and top sections angled outwards from said wheel.

15. The system of claim 14 further comprising a coating between the metallic and/or ceramic sheet surfaces and the wheel, said coating configured to facilitate separation of the wheel mold and the wheel.

16. The system of claim 10 wherein said surface truing unit is configured to: remove excess material, apply pressure using rollers or hammers and/or shot peen the wheel surface.

17. The system of claim 10 further comprising a prep unit configured to cut grooves or channels in the rail and to install reinforcing bars and/or rods into the grooves and channels in the rail.

18. A method of repairing rail or wheel comprising:
cleaning a surface of said rail or wheel to be repaired;
placing said rail in a rail mold or said wheel in a wheel mold, said rail mold and wheel mold configured to prevent leakage of molten metal;
placing fusible flux on said surface of said rail or said wheel to be repaired;
melting one or more metals into molten metal to be used to repair said rail or said wheel;
dispensing, in one or more layers, said molten metal onto said surface of said rail or said wheel to be repaired; and
after dispensing said molten metals, treating said rail or wheel to remove any excess metal.

19. The method of claim 18 further comprising heating said surface of said rail or said wheel, prior to repair, to reduce thermal and mechanical stresses which may occur during repair.

20. The method of claim 18 further comprising controlling the rate at which said surface of said rail or said wheel cools to ambient temperature after being repaired to minimize thermal and mechanical stresses.

21. The method of claim 18 further comprising utilizing a water jet and/or flame burning for cleaning a surface of said rail or wheel to be repaired.

22. The method of claim 18 further comprising cutting grooves or channels in the rail or wheel and installing reinforcing bars and/or rods into said grooves and channels.

23. The method of claim 18 further comprising utilizing at least one pair of metal wires melted in a sealed container via electrical energy and retained in a molten stage by heating elements within said container for melting one or more metals into molten metal to be used to repair said rail or said wheel.

24. The method of claim 18 further comprising utilizing an additive manufacturing unit for melting one or more metals into molten metal to be used to repair said rail or said wheel; and dispensing, in one or more layers, said molten metal onto said surface of said rail or said wheel to be repaired.

25. The method of claim 18 further comprising utilizing an additive manufacturing unit with an air-tight container for melting one or more metals into molten metal to be used to repair said rail or said wheel; and dispensing, in one or more layers, said molten metal onto said surface of said rail or said wheel to be repaired.

26. The method of claim 18 further comprising adding an inert gas into a container holding said molten metal.

27. The method of claim 18 further comprising adding reinforcing composite materials to the molten metal before dispensing the same onto said rail or said wheel.
